(19) United States
(12) Patent Application Publication
(10) Pub. No.: US 2009/0187273 A1
(43) Pub. Date: Jul. 23, 2009

(54) METHOD AND APPARATUS FOR CONTROLLING A VENDING MACHINE

(76) Inventor: Donald Liu, Las Vegas, NV (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/327,405

(22) Filed: Dec. 3, 2008

Related U.S. Application Data
(60) Provisional application No. 61/022,074, filed on Jan. 18, 2008.
(60) Provisional application No. 61/022,060, filed on Jan. 18, 2008.

(51) Int. Cl. G06F 17/00; G07F 7/04

(52) U.S. Cl. 700/231; 194/206

(57) ABSTRACT

A method and apparatus are provided for controlling a number of functions within a vending machine. The method includes the steps of providing a central processing unit, coupling a USB class controller to the central processing unit, and controlling the vending machine by the central processing unit through the USB to serial controller.

### FIELD OF THE INVENTION

The Field of the invention relates to dispensing devices and more particularly to vending machines.

### BACKGROUND OF THE INVENTION

Automatic vending machines are generally known. Such devices are typically used where ever a need exists for goods, but the volume does not justify the use of a full time employee.

Vending machines may be used to dispense any of a variety of goods (e.g., candy, softdrinks, etc.). In addition to dispensing the goods, the vending machine may also need to prepare the good for sale. For example, a softdrink machine may need to maintain the softdrink at a low temperature in order to attract customers. Similarly, a coffee vending machine may need to heat the water for making the coffee. In addition to heating the water, the coffee vending machine may dispense a cup before actuating a set of valves that pass the water through coffee grounds and into the cup.

Some vending machines are relatively simple in construction requiring only a payment detector and actuator for dispensing the dispensed good. The payment detector may be a bill validator or even a credit card reader. Bill validators may be provided to accept one specific type of currency (e.g., a one-dollar bill) or a number of different types of currencies (e.g., a quarter, a one-dollar bill, a five-dollar bill, etc.).

Vending machines may be provided by any of a number of different manufacturers and operate under any of a number of different formats. For example, some vending machines may include a bill validator that only accepts exact change and then simply provides a contact closure to activate a dispensing unit (e.g., a solenoid). Other vending machines may include a controller that receives a number of different types of currencies and operates a number of actuators in a particular sequence to prepare a vended product.

While vending machines operate under many different formats, there is no common format of control. Because of the importance of automated vending, a need exists for a standard of operation that may be applied to many different vending actuators and bill validators.

### SUMMARY

A method and apparatus are provided for controlling a number of functions within a vending machine. The method includes the steps of providing a central processing unit, coupling a Universal Serial Bus (USB) class controller to the central processing unit, and controlling the vending machine by the central processing unit through the USB to serial controller.

### BRIEF DESCRIPTION OF THE DRAWING

FIG. 1 is a block diagram of a control system for a vending machine in accordance with an illustrated embodiment of the invention;

FIG. 2 is a block diagram of a supervisory system that may be used with the system of FIG. 1; and

FIG. 3 is a block diagram of signal processing system that may be used with the system of FIG. 1.

### DETAILED DESCRIPTION OF AN ILLUSTRATED EMBODIMENT

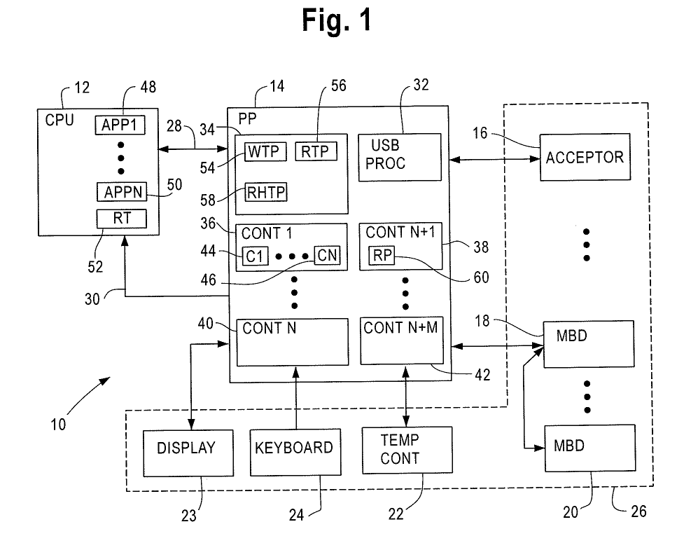

FIG. 1 is a block diagram of a vending machine controller 10 shown generally in accordance with an illustrated embodiment of the invention. Included within the system 10 may be a central processing unit 12 and one or more a protocol processors 14 that interface with a number of different vending machine subsystems 16, 18, 20, 22, 24 disposed within a single vending machine 26 (as shown in FIG. 1) or the vending machine subsystems 16, 18, 20, 22, 24 may represent portions of different vending machines 26 all controlled by a single CPU 12. Even though the system 10 will be described in the context of a vending machine 26, it should be apparent that the system 10 is also applicable to ATMs, gaming, amusement, transport or Internet cafe devices.

The vending machine subsystems 16 18, 20, 22, 24 may be directed to different functions within a vending machine. For example a first subsystem 16 may be a bill validator that accepts currency (e.g., one-dollar bills, five-dollar bills, etc.). Another subsystem 22 may be a temperature control subsystem that controls a refrigeration unit or heater of the vending machine 26 while other subsystems 18, 20 may be actuators that prepare and/or dispense the product. Still another subsystem 24 may be a keyboard that accepts an identifier of a vended product. Another subsystem 23 may be a display screen that displays vended products and prices or advertisements of vended products.

The CPU 12 may be a personal computer (PC) having an appropriate operating system (e.g., Microsoft Windows, Mac OS, Linus, etc.) and having at least one USB port for a USB cable 28. The protocol processor 14 is based upon use of an industrial standard controller chipset or USB controller (e.g., an FTDI chip, part number FT232RL (www.ftdichip.com), or equivalent) 32 that supports any of a number of appropriate operating systems (OSs) (e.g., Windows 98, ME, 2K, XP, Vista; Linux; Mac Oss 8, 9, X, etc.).

It should be noted in this regard that the USB controller 32 operates under a USB-to-Serial Device Class. More specifically, the chipset 32 does not operate under a USB Human Interface Device (HID) class.

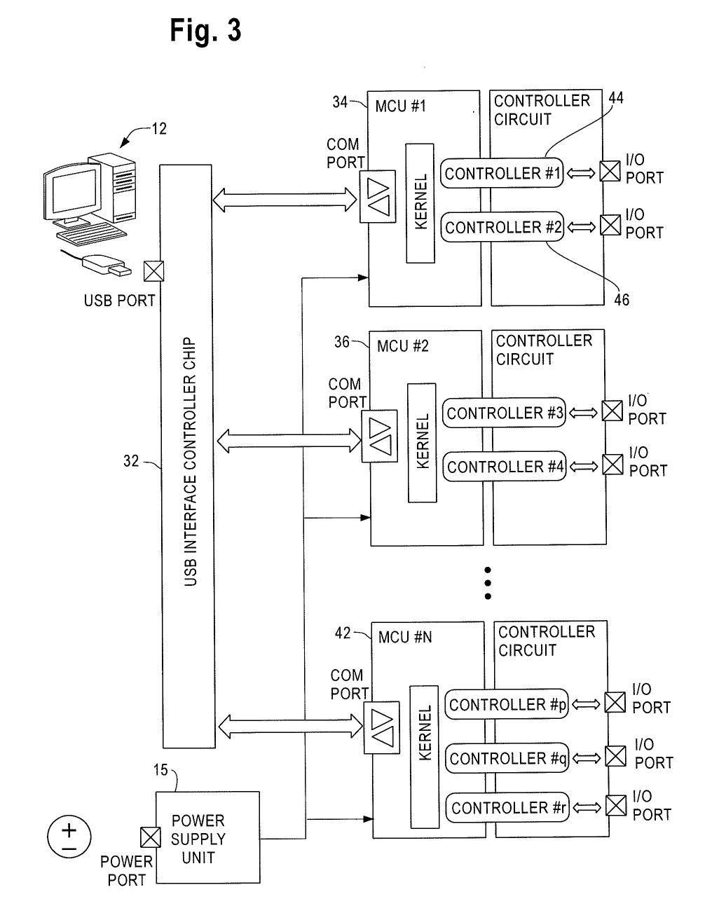

In general, the USB chipset 32 provides a serial connection with a number of multipoint control units (MCUs) 34, 36, 38, 40, 42 as shown in more detail in FIG. 3. Each MCU 34, 36, 38, 40, 42 may have several function controllers or processors 44, 46 that each operate in parallel to serve different functions within the vending machine 26. The MCUs 34, 36, 38, 40, 42 are provided with a separate power supply 15 to accommodate the various power requirements (e.g., voltage) and communication speed, formats, hardware, etc.

The USB controller 34 is a high speed chip set that conforms to the USB 2.0 (or USB 1.0 or USB 1.1) standard established by the USB-IF. The main purpose of the USB controller 32 is to interconnect each function processor 44, 46 of each MCU for purposes of exchanging user messages between the processors 44, 46 of each MCU 34, 36, 38, 40, 42 and respective applications 48, 50 within the CPU 12.

The applications 48, 50 may be user interface applications that allows a user to monitor parameters within the respective subsystems 16, 18, 20, 22, 24 or control applications 48, 50 that control operation of the respective subsystems 16, 18, 20, 22, 24. In this regard, each processor 44, 46 of each MCU 34, 36, 38, 40, 42 has its own unique address for direct access by the applications 48, 50. Only the controller 44, 46 with a matching address will reply to a request from an application 48, 50. In the case of more than one MCU (as shown in FIG. 1), the MCUs are daisy-chained together so that they see the same messages.

The controller 44, 46 are the building blocks of the MCU. They are the actual functioning units that the user (and user applications) interact with. Each controller 44, 46 occupies a memory area, a program code area, and/or physical I/O pins. As set forth above, each controller 44, 46 has a unique ID.

Each controller 44, 46 has its own intelligence to communicate with its designated subsystem 16, 18, 20, 22, 24. That intelligence may be used to convert a protocol required by the subsystem to a common protocol understandable by the CPU 12. For example, one controller 44, 46 may be a bill acceptor port to detect credits received from a bill acceptor. At start-up, the controller 44, 46 receives information from the user applications 48, 50 about the type, credit values, and the behavior of the connected bill acceptor 16. Once the proper information has been loaded, the controller 44, 46 may communicate with the bill acceptor 16 under a predetermined format required by the bill acceptor 16 and report any events to the CPU 12 under the protocol required by the CPU 12. The user does not need to know the exact communication format used between the controller 44, 46 and bill acceptor.

Upon start-up of the CPU 12, the OS (Windows) registers the USB device and prepares it for use using a process called enumeration. When a device first plugs into a USP port, OS receives the vendor ID (VID) and product ID (PID) from the device. By using the two IDs, the OS is able to identify the correct driver files (*.inf)/system files (*.sys)/dynamic link library files (*.dll)/etc. The device is then added as a USB-to-serial class device and a communication controller chip (e.g., a FT232) of the device is assigned a HandleID by the OS. The application programs 48, 50 use the HandleIDs to access the communication controller chip of the controllers 44, 46.

Each MCU 34, 36, 38, 40, 42 has its own firmware, known as a kernel. The kernels are flash ROM based.

Each controller 44, 46 may also be provided with a specific set of command instruction sets that may be used by the user application control programs 48, 50 in the control of the respective peripherals 16, 18, 20, 22, 23, 24.

While the controllers 44, 46, in general, only respond to instructions addressed to a specific controller 44, 46, the controllers 44, 46 are also constructed to respond to a set of global commands. One global command may be a device RESET. The device RESET functions to reset all controllers 44, 46 including the controllers of the supervisory system 34. Once reset, any operating parameters must be re-installed.

Another global command that may or may not be present is an ADDRESS CLASH command. This command requests all controllers 44, 46 within the device 14 to report their presence by replying with their respective controller ID. In order to avoid multiple controllers 44, 46 sending their IDs at the same time, the system 14 incorporates a time scheme for reporting. The timing scheme requires that each controller 44, 46 send its ID based upon the numerical value of the ID multiplied by 5 ms. For example, a controller 44, 46 with a controller ID of 10 hex (16 dec) would reply at 16×5 ms or 80 ms after receiving the ADDRESS CLASH command.

When present, the ADDRESS CLASH command may be used by a user to identify each controller within the system 14. Once identified, the command ID of each controller 44, 46 may be used to access the controllers 44, 46 for purposes of programming the control of or the monitoring of each subsystem 16, 18, 20, 22, 23, 24.

Another global command that may or may not be used is a GLOBAL SUSPEND command. The GLOBAL SUSPEND command instructs those controller 44, 46 that recognize the command (except the controllers of the supervisory system 34) to cease operation and enter a suspend mode. Depending upon the function of the controller 44, 46, some controllers will deactivate the attached subsystem or some will finish the current event before suspending operation.

Another command is a USER SUSPEND command. This command places a respective controller 44, 46 into a suspended operation condition. Depending upon the function of the controller 44, 46, the controller may deactivate the attached peripheral or will finish a current operation before suspending operation.

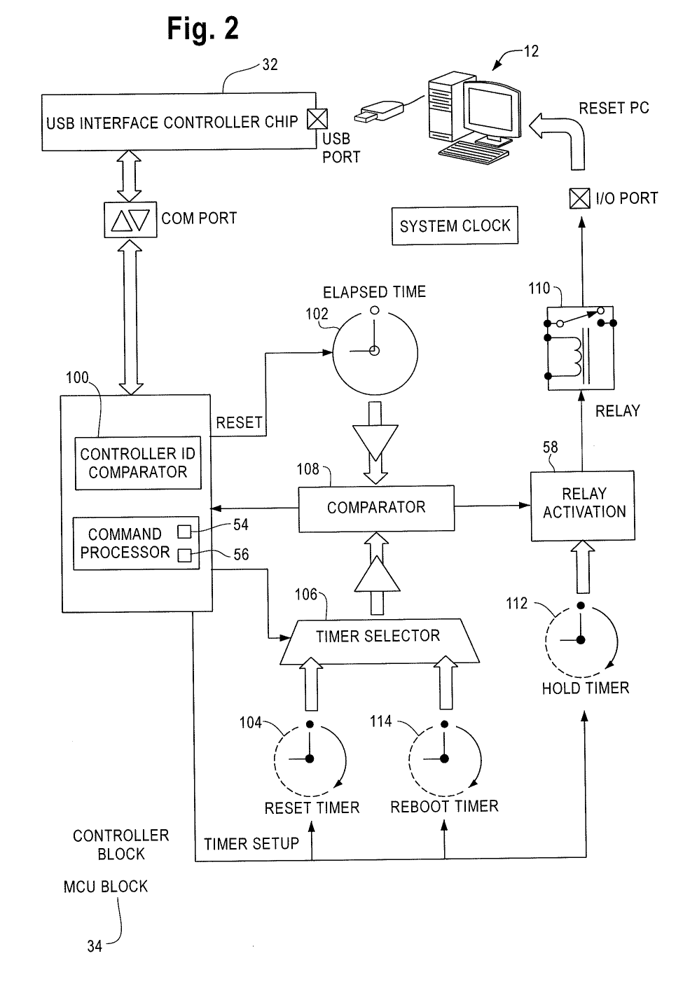

Any of a number of different types of functionality may be provided by the MCUs 34, 36, 38, 40, 42 and/or specific controllers 44, 46. For example, one type of functionality may a PC supervisory system (FIG. 2) located at controller ID 9 (hex). In this regard, PC technology has advanced to the point where the CPU 12 can do multiple tasks at the same time and be located in an unattended area where it is left unsupervised for prolonged periods of time. However, applications 48, 50 are often complicated and cause a varying level of interference among themselves and with the OS. It is a common problem for any given set of applications operating over some time period that one of the applications will malfunction, causing the CPU 12 to “freeze up” or, otherwise, stop functioning.

In order to address this problem, a PC supervisory system 34 is provided to avoid such indefinite loss of function of the CPU 12. Once activated the PC supervisory system 34 must periodically receive an activity notification packet (a ping) from an application 52 within the CPU 12. Should the supervisory system 34 fail to detect a ping packet, then the supervisory system 34 will generate a hard reset through a hardwired connection 30 physically connected to a set of reset pins on a motherboard of the CPU 12.

In that regard, a timing application 52 may periodically send pings addressed to a watchdog time processor 54 within the supervisory system 34. The ping is routed by the USB controller 32 to a controller ID comparator 100 which determines that the packet is intended for the watchdog timer processor 54 and forward the packet accordingly. Each time a ping message is received, the watchdog time processor 54 sets or resets an internal timer 102. After each ping, the time processor 54 selects a reset time value 104 using a timer selector 106. A comparator 108 compares the accumulated time 102 with a threshold value (e.g., 5 minutes) 104. When the accumulated time exceeds the threshold, the comparator 106 activates a reset time processor 58 and a reboot time processor 56.

The reset time processor 58 controls a dry contact relay 110 and actives the relay 110 for a predetermined time period in accordance with how long the hard reset is applied to the CPU 12. In this regard, the reset time processor 58 may activate the reset relay 110 and maintain activation of the relay 110 until an internal timer matches a predetermined hold time 112 (e.g., 2 seconds) resulting in the deactivation of the relay 110.

Activation of the comparator 106 may also activate a reboot time processor 56. The reboot time processor 56 prevents the watchdog timer processor 54 from applying another hard reset to the CPU 12 for some time period sufficient for the CPU 12 to reboot. In this case, activation of the reboot time processor 56 causes the time selector 106 to select a reboot threshold time (e.g., 20 minutes) 114 for comparison within an elapsed time from timer 102 within the comparator 108. While the accumulated time is less than the reboot threshold 114, the reboot time processor 56 holds the watchdog processor 54 in a reset state. Once the accumulated time exceeds the reboot threshold, the reboot processor 56 releases to watchdog time processor 54. If the watchdog time processor 54 has received a packet ping message in the interim, then the watchdog timer 54 resets the timer 102. Otherwise, if the watchdog time processor 54 did not receive a packet ping during the reboot time period, the watchdog timer 54 generates another reset and the process repeats.

Another controller 44, 46 may be for a bill/coin acceptor 16 with pulse/parallel/binary input options located at address 10 (hex). This controller 44, 46 is designed to operate with most bill/coin acceptors that may have different I/O requirements. For example, the acceptor may detect receipt of currency and provide an output in a simple pulse, parallel or binary format. In each case, a reformatting processor 60 within the controller 44, 46 detects each event/status message from the acceptor 16 and reformats the message into an easy to use event reporting packet for transfer to the CPU 12. For each event request poll sent by a user application 48, 50, the controller 44, 46 responds with the 6 most recent event/status messages received from the acceptor 16 together with an event number.

In general, the bill/coin acceptor controller 44, 46 may use a 10 pin connector with 6 credit value connections. In the case of a simple pulse input format, the acceptor 16 provides a series of pulses on an output line proportional to the number of credit(s) received. Use of any one of the 6 output lines is possible.

In the case of a standard parallel input from the bill acceptor 16, the controller 44, 46 may use of to 6 individual output lines from the acceptor 16 to represent 6 different distinct credit values. Each pulse on an output line represents a particular credit value that has been accepted. Simultaneous outputs are possible on the 6 lines.

In the case of binary outputs, the acceptor 16 may use up to 4 output lines to send credit information to the controller 44, 46 in a binary format. Up to 15 different credit channels (values) may be provided.

Another controller 44, 46 may be a MDB/ICP host controller located at address 12 (hex). MDP or ICP is a communication standard widely adopted by the vending machine manufacturers for communication among bill acceptors, coin changers, card readers, etc. and a host system. Multi-Drop Bus (MDB) communication employs an 11-bit serial byte format. The mode bit (i.e., the 9^{th} bit of the byte) dictates the direction of the message. This unique arrangement has, in the past, prevented PC based serial ports from handling MDP data. Moreover, the 5 ms response time frame specified in MDB specification v3.0 has prevented the use of a non-real-time-system such as the CPU 12 with MDB devices. In each case, a reformatting processor 60 is provided to convert between the MDB format used by the subsystem 18, 20 and the packet format used by the CPU 12.

In general, there are two modes that can be used by the controller 44, 46. The first is the controller mode. In the controller mode, a first standard peripheral (e.g., bill acceptor; MDB Address 30H, Level 1) and a second standard peripheral (e.g., coin changer; MDB Address 08H, Level 2) are supported. Either one peripheral or both can be connected together to the system 10 in a daisy chain manner.

This mode simplifies programming for a user who wants to focus on his application rather than encoding and decoding the MDB communications. Minimal MDB knowledge and interaction is required. Once setup, the controller 44, 46 will initiate communication with the peripheral and begin accessing its features. The operation sequence includes accessing a controller mode setup routine followed by a searching routine, a status setup routine, a send enable command followed by a polling routine. Polling may be repeated every 400 ms. Upon receiving different poll reports, the controller may intelligently switch to different routine handles (e.g., accept a bill if the poll report is a bill credit acceptance, reject a transaction if the user has not inserted enough money or issue a credit to the vending machine control completing the transaction if the poll report is a bill stacked message indicating that a bill has been loaded into a cash cassette).

The second mode is open mode. In open mode, the user has full access to all MDB commands, including the BUS reset. Users can program for his/her chosen peripheral and do the polling at his/her discretion. The user can also daisy chain additional peripherals onto the MDB bus in compliance with the MDB specification.

A specific embodiment of method and apparatus for operating a vending machine has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of controlling a plurality of functions of a vending machine comprising:
providing a central processing unit;
coupling a USB class controller to the central processing unit;
controlling the vending machine by the central processing unit through the USB to serial controller.

2. The method as in claim 1 wherein the USB class controller further comprises a USB to serial class controller.

3. The method as in claim 2 further comprising coupling a multipoint control unit between the USB to serial class controller and vending machine.

4. The method as in claim 2 further comprising coupling a function controller between the multipoint control unit and vending machine.

5. The method as in claim 4 further comprising the function controller converting between a multi-bus drop format and a predetermined protocol of the central processing unit.

6. The method as in claim 4 further comprising coupling a bill acceptor of the vending machine to the central processing unit through the function controller.

7. The method as in claim 4 further comprising coupling a product selection keyboard of the vending machine to the central processing unit through the function controller.

8. The method as in claim 3 further comprising monitoring the central processing unit for activity through the multipoint controller.

9. The method as in claim 8 wherein monitoring further comprises periodically detecting an activity notification message from the central processing unit within a function processor coupled to the multipoint controller.

10. The method as in claim 9 further comprising the controller generating a reset pulse in the absence of an activity notification message.

11. The method as in claim 9 further comprising the controller blocking the generating a second reset pulse for a reboot time period.

12. An apparatus for controlling a plurality of functions of a vending machine comprising:
a central processing unit;
means for coupling a USB class controller to the central processing unit;
means for controlling the vending machine by the central processing unit through the USB to serial controller.

13. The apparatus as in claim 13 wherein the USB controller further comprises a USB to serial class controller.

14. The apparatus as in claim 13 further comprising means for coupling a multipoint control unit between the USB to serial class controller and vending machine.

15. The apparatus as in claim 14 further comprising means for coupling a function controller between a multi-drop bus format to a predetermined format thereby allowing and vending machine.

16. The apparatus as in claim 15 further comprising means within the function controller for converting between a multi-bus drop format and a predetermined format of the central processing unit.

17. The apparatus as in claim 15 further comprising means for coupling a bill acceptor of the vending machine to the central processing unit through the function controller.

18. The apparatus as in claim 15 further comprising means for coupling a product selection keyboard of the vending machine to the central processing unit through the function controller.

19. The apparatus as in claim 14 further comprising means for monitoring the central processing unit for activity through the multipoint controller.

20. The apparatus as in claim 19 wherein monitoring further comprises means for periodically detecting an activity notification message from the central processing unit within a function processor coupled to the multipoint controller.

21. The apparatus as in claim 20 further comprising means within the controller for generating a reset pulse in the absence of an activity notification message.

23. The apparatus as in claim 20 further comprising means within the controller for blocking the generating a second reset pulse for a reboot time period.

24. An apparatus for controlling a plurality of functions of a vending machine comprising:
a central processing unit;
a USB class controller coupled to the central processing unit; and
a multipoint controller that controls the vending machine by exchanging a respective signal between the central processing unit and each of the plurality of functions through the USB to serial class controller.

25. The apparatus as in claim 24 wherein the USB class controller further comprises a USB to serial class controller.

26. The apparatus as in claim 25 further comprising means a function controller between the multipoint control unit and each of the plurality of functions of the vending machine.

27. The apparatus as in claim 26 further comprising a protocol converter within the function controller that converts between a multibus drop format and a format of the USB to serial class controller.

28. The apparatus as in claim 26 wherein the plurality of functions further comprises a bill acceptor.

29. The apparatus as in claim 26 wherein the plurality of functions further comprises a product selection keyboard.

30. The apparatus as in claim 26 further comprising a supervisory system that monitors the central processing unit for activity through the multipoint controller.

31. The apparatus as in claim 30 wherein monitoring further comprises an activity notification message from the central processing unit that is detected by a watchdog time processor within a function processor coupled to the multipoint controller.

32. The apparatus as in claim 31 further comprising a reset pulse that is generated by the watchdog time processor in the absence of an activity notification message.

33. The apparatus as in claim 32 further comprising a reboot time processor within the controller for blocking the generating a second reset pulse for a reboot time period.
